(19) United States
(12) Patent Application Publication
(10) Pub. No.: US 2007/0116184 A1
(43) Pub. Date: May 24, 2007

(54) Method for testing the integrity of a communication cable

(75) Inventors: Brian Gonsalves, Concord, CA (US); Zesen Chen, Pleasanton, CA (US)

Correspondence Address: AKERMAN SENTERFITT, P.O. BOX 3188, WEST PALM BEACH, FL, 33402-3188, US

(73) Assignee: SBC Knowledge Ventures LP, Reno, NV (US)

(21) Appl. No.: 11/248,389

(22) Filed: Oct. 12, 2005

(51) Int. Cl. H04M 1/24; H04M 3/08; H04M 3/22

(52) U.S. Cl. 379/1.01

(57) ABSTRACT

A method is disclosed for testing the integrity of a communication cable. A method that incorporates teachings of the present disclosure may include, for example, a smart network interface (SNI) (114) has a communications device (202) located at a building (112) and coupled to a portion (111) of a cable (109) of a communications network (100), and a controller (204). The controller is programmed to intercept (308) a request to test the cable, and perform (310, 312, 314) an integrity test on the cable according to said request.

### FIELD OF THE DISCLOSURE

The present disclosure relates generally to testing telecommunication cables, and more specifically to a method for testing the integrity of a communication cable.

### BACKGROUND

Splicing (the process of joining two ends) is a common practice used during installation and/or repair of communication cables. Typically, a large number of residential and/or commercial communication lines are bundled in one cable. It is not uncommon, for example, for a single cable to support hundreds if not thousands of consumers. Therefore, validating the integrity of a spliced cable is critically important.

To validate a spliced cable, testing is typically performed by a manual procedure such as originating a POTS (Plain Old Telephone Service) call on each line. For obvious reasons this process is lengthy, costly, and prone to error.

A need therefore arises for a method for enhanced testing of communication cables.

### BRIEF DESCRIPTION OF THE DRAWINGS

FIG. 1 is a block diagram of power and communication cabling between a central office and a service access interface according to teachings of the present disclosure;

FIG. 2 is a block diagram of a smart network interface (SNI) according to teachings of the present disclosure;

FIG. 3 depicts a flowchart of a method operating in the communications network according to teachings of the present disclosure; and

FIG. 4 is a diagrammatic representation of a machine in the form of a computer system within which a set of instructions, when executed, may cause the machine to perform any one or more of the methodologies discussed herein.

### DETAILED DESCRIPTION

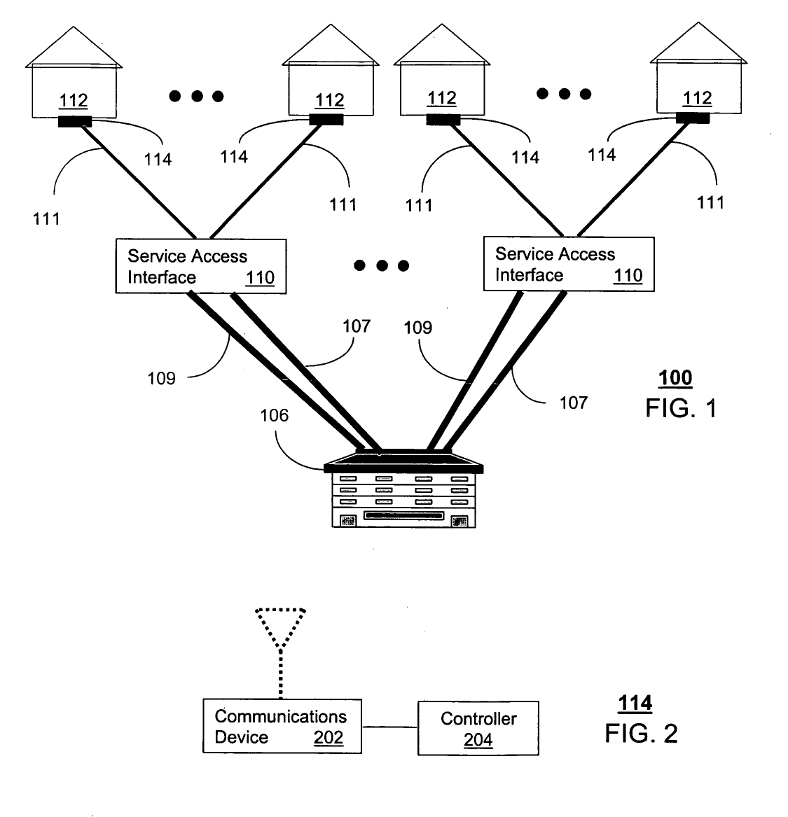

FIG. 1 is a block diagram of power and communication cabling between a central office (CO) 106 and a service access interface (SAI) 110 according to teachings of the present disclosure. The CO 106 distributes telecommunication services by way of the SAI 110 to buildings 112 (such as dwellings or commercial enterprises). For illustration purposes only, buildings 112 will be referred to herein as residences 112. Telecommunication services of the CO 106 can include traditional POTS (Plain Old Telephone Service) and broadband services such as HDTV, DSL, VoIP (Voice over Internet communications, IPTV (Internet Protocol Television), Internet services, and so on.

Links 107 are twisted copper pairs for distributing power to the SAIs 110. Alternatively, links 107 can be coupled to local commercial power near the SAIs 110 supplied by, for example, a utility company. The SAI 106 can be coupled to optical and/or electrical cables 109 from the CO 106, which carry any one or more of the aforementioned communications services. These services can be processed in part by active circuits in the SAI 106 and/or circuits at the residences 112. Each cable 109 carries communication links numbering in the hundreds or thousands. The SAI 110 serves to distribute portions of cable 109 among the residences 112 as dedicated communication links 111. Thus, the SAI 110 serves as a local cross connect system for unbundling communication links of the cable 109.

The communication links 111 terminate at a smart network interface (SNI) 114 coupled to a residence 112. SNIs 114 can monitor and test the integrity of links 111, as well as relay services into the residences 112. FIG. 2 depicts a block diagram of an SNI 114 according to teachings of the present disclosure. The SNI 114 includes a communications device 202 for intercepting messages such as may be generated by the CO 106 or a field service agent associated with the CO 106. The communications device 202 can receive messages wirelessly or by way of link 111.

The communication device 202 can be a receiver unit only, or can also include a transmitter for submitting messages. As a transceiver, the communication device 202 utilizes common technology for exchanging messages with personnel of the CO 106. Any common communication medium can be used for exchanging messages. For example, in a wireless embodiment, the communication device 202 can utilize WiFi, WiMax, or cellular, among other wireless technologies. Alternatively, the communication device 202 can communicate by way of link 111. In either embodiment, the communications protocol can be a common protocol such as the Internet Protocol, or other suitable protocol for exchanging messages.

The SNI 114 further includes a controller 204 for controlling operations of the SNI with computer instructions programmed therein according to teachings of the present disclosure. The controller 204 utilizes common computing technology such as a microprocessor, a digital signal processor (DSP), or a custom ASIC (Application Specific Integrated Circuit) state machine. These computing devices can have internal or external storage media such as a RAM, SRAM, Flash, or other common storage element(s).

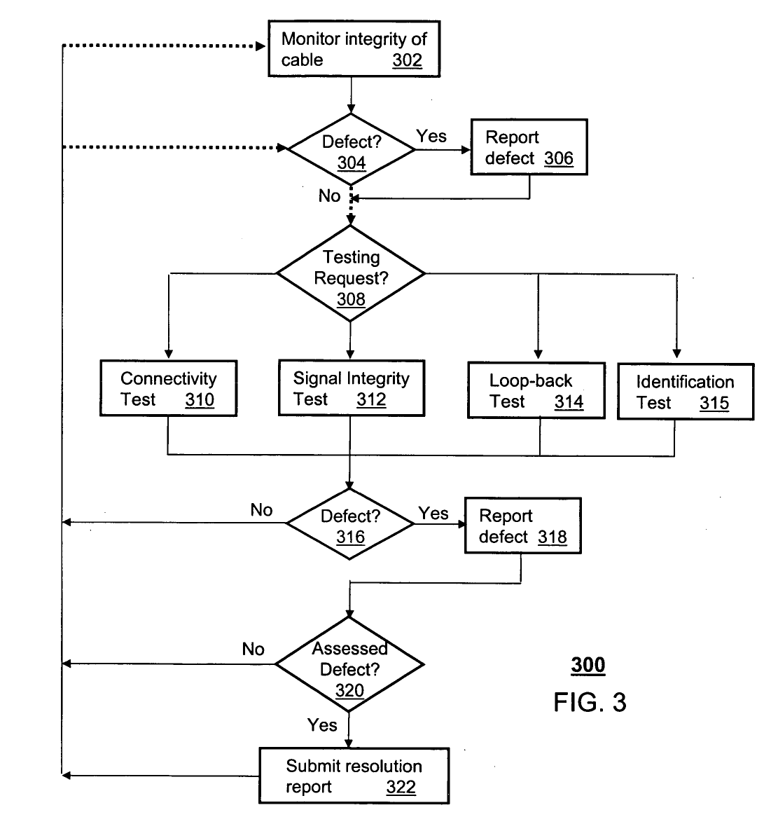

FIG. 3 depicts a flowchart of a method 300 operating in the communications network 100 according to teachings of the present disclosure. Method 300 begins with step 302 where the SNI 114 is programmed to monitor the integrity of link 111 by common means. For example, integrity testing can be verified by receiving and testing periodic pulses generated by the CO 106 or the SAI 110. Alternatively, a sequence of digital or analog signals can be used for more sophisticated testing. Cable integrity can also be tested by measuring the signal strength of test signals, performing loop-back testing, or by other common means for assessing a quality of communications. If a defect is detected in step 304, the SNI 114 proceeds to step 306 where it submits a report. The report can be stored locally at the SNI 114 for periodic monitoring by field personnel of the communications network 100, or can be submitted by electronic or over-the-air transmission to a management device such as a network management system of the CO 106. A defect in the present context can mean any signal anomaly detected by the SNI 114. Steps 302 through 306 can operate as a background process which can operate autonomously at, for example, periodic intervals established by the service provider of the communication network 100.

Steps 308 through 322, on the other hand, can operate as a foreground process for proactively testing on demand links 111. In step 308, the SNI 114 checks for the arrival of a request for testing an associated link 111. The source of the request can be an operator of the CO 106 working in conjunction with a field service agent. Alternatively, the source can be a field service agent carrying a portable device capable of communicating with one or more SNIs 114 wirelessly or by way of links 111. The request can be motivated by a field agent who would like to verify the integrity of links 111 of corresponding residences 112 which are sourced by a cable 109 that the agent has, for example, spliced in the field as part of ordinary maintenance, repair, installation, or otherwise. Alternatively, the agent can request testing with one or more SNI 114 for diagnosing a trouble reported with one or more communication links 111.

Testing can take the form of one or more test embodiments such as shown in steps 310, 312, 314, and 315. For example, the field agent may want simply to test connectivity between links 111 and the CO 106 so as to validate that the proper connections were made as part of a splicing occurrence. A connectivity test can be performed by common techniques such as transmitting a signal from the CO 106, intercepting the signal at the SNI 114 and submitting an acknowledgment back to the CO 106 on link 111. The source of the signal and corresponding acknowledgment can also be reversed, in which case the SNI 114 submits the test signal to the CO 106 with the expectation of receiving and acknowledgment from the CO. Test messages such as video, data, pseudo-random patterns, or other signaling exchanges can be employed during the connectivity test of step 310. There are innumerable connectivity techniques that can be applied to step 310, which cannot be reasonably described in the present disclosure, but which an artisan with ordinary skill in the art would recognized as being within the scope and spirit of the claims described below.

Alternatively, or in addition to step 310, the SNI 114 can be programmed to perform a signal integrity test at step 312. This step can test for a bit error rate associated with a set of pseudo-random sequences exchanged between the CO 106 and the SNI 114. It can also perform a signal to noise ratio test, signal reflection testing, echo testing, jitter, and countless other signal integrity tests. Similarly, in step 314 the SNI 114 can be programmed to perform loop-back tests in which the CO 106 originates signals which are looped back by the SNI 114 to the CO 106.

In step 315, the SNI 114 can be programmed to perform an identification test. The identification test can comprise, for example, submitting a form of identification to the CO 106 (or to the requesting agent of the CO) including any combination of a telephone number of the residence 112, the residence address, cable pair numbers (e.g., cable 10, pair 1), an ID (e.g., serial no.) of the SNI 114, and so on. Any form of identification received on the cable 109 can be compared to an expected identification. If the identification transmitted by the SNI 114 is received from on an incorrect link at the CO 106, then the CO and/or its agent can ascertain that the splicing process has a defect. Moreover, this defect can be synthesized to identify the incorrect connections in the spliced cable.

If a defect is found in step 316 from any of these tests, the SNI 114 proceeds to step 318 where it submits a report. A defect can be triggered by a connectivity defect or any number of predetermined thresholds preprogrammed in the controller 204 of the SNI 114 for testing purposes. A predetermined threshold can be, for example, a maximum bit error rate threshold, a minimum signal strength threshold, a minimum signal to noise ratio, and so on. The report generated in step 318 can be stored by the controller 204 or submitted wirelessly or by way of link 111 to the CO 106 or the field service agent requesting the test. The report can include, for example, telemetry information relating to any of the aforementioned tests. The report can also include time stamps associated with data transmissions and associated raw data intercepted by the SNI 114. Hence, any reporting structure can be submitted for diagnostic purposes.

In a supplemental embodiment, the telemetry information can be assessed in step 320, and a resolution report can be generated therefrom in step 322. The assessment step can be embodied in the SNI 114, the CO 106, a portable device carried by the field agent, or combinations thereof. That is, the SN 114 can be programmed with common algorithms to detect the source of the defect, and on a limited basis provide suggested mitigation steps according to a preprogrammed knowledge database stored in the SNI 114. Alternatively, the assessment process can be performed at the CO 106 by more sophisticated knowledge-based systems capable of performing a more comprehensive analysis. The field agent's portable device can perform similar analysis and synthesis for generating a graphical user interface that describes the defect and its resolution. For example, the field agent can see from a display of the portable device that the spliced cable has links 111 of more than one residence 112 which have been cross-wired. The resolution report can thus include suggestions that may be useful to the agent in identifying the source of a defect and steps for mitigation. Once the defect(s) have been resolved, the foregoing steps of method 300 can be repeated for subsequent cycles.

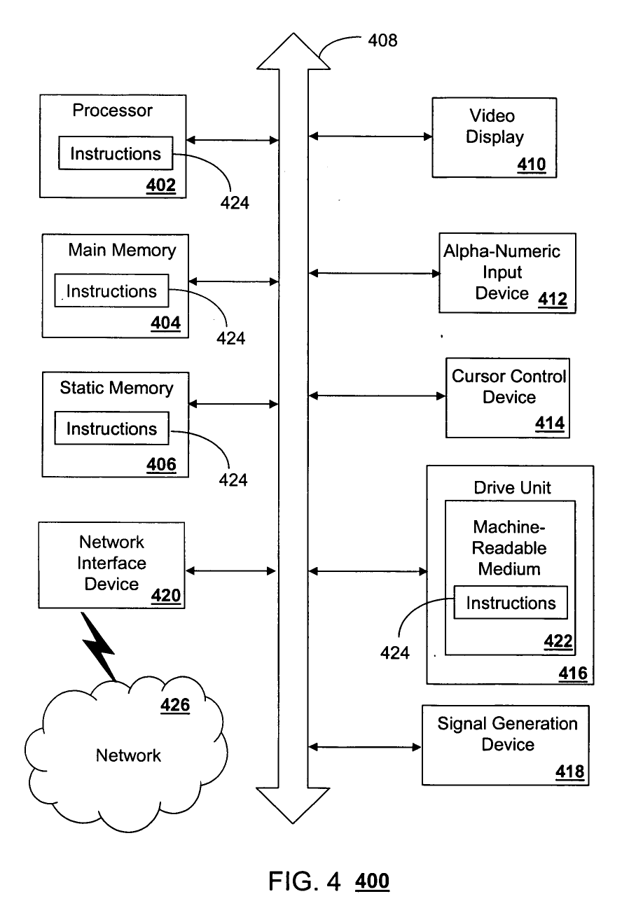

FIG. 4 is a diagrammatic representation of a machine in the form of a computer system 400 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 400 may include a processor 402 (e.g., a central processing unit (CPU), a graphics processing unit (GPU, or both), a main memory 404 and a static memory 406, which communicate with each other via a bus 408. The computer system 400 may further include a video display unit 410 (e.g., a liquid crystal display (LCD), a flat panel, a solid state display, or a cathode ray tube (CRT)). The computer system 400 may include an input device 412 (e.g., a keyboard), a cursor control device 414 (e.g., a mouse), a disk drive unit 416, a signal generation device 418 (e.g., a speaker or remote control) and a network interface device 420.

The disk drive unit 416 may include a machine-readable medium 422 on which is stored one or more sets of instructions (e.g., software 424) embodying any one or more of the methodologies or functions described herein, including those methods illustrated above. The instructions 424 may also reside, completely or at least partially, within the main memory 404, the static memory 406, and/or within the processor 402 during execution thereof by the computer system 400. The main memory 404 and the processor 402 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 424, or that which receives and executes instructions 424 from a propagated signal so that a device connected to a network environment 426 can send or receive voice, video or data, and to communicate over the network 426 using the instructions 424. The instructions 424 may further be transmitted or received over a network 426 via the network interface device 420.

While the machine-readable medium 422 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A smart network interface (SNI), comprising:
a communications device located at a building and coupled to a portion of a cable of a communications network;
a controller for controlling operations of the communications device, and programmed to:
intercept a request to test the portion of the cable; and
perform an integrity test on the portion of the cable according to said request.

2. The SNI of claim 1, wherein the controller is programmed to perform connectivity testing between end points of the portion of the cable.

3. The SNI of claim 1, wherein the controller is programmed to:
detect a defect in the portion of the cable; and
report said defect to a service provider of the communications network.

4. The SNI of claim 1, wherein the controller is programmed to perform signal integrity testing on the portion of the cable.

5. The SNI of claim 1, wherein the controller is programmed to perform loop-back testing on the portion of the cable.

6. The SNI of claim 1, wherein the controller is programmed to perform identification testing on the portion of the cable.

7. The SNI of claim 1, wherein the controller is programmed to intercept the request over at least one among a wireless communication medium, and the portion of the cable.

8. The SNI of claim 1, wherein the building comprises one among a dwelling, and a commercial enterprise.

9. A computer-readable storage medium, comprising computer instructions for:
monitoring from a building the integrity of a portion of a cable of a communications network;
detecting a defect in the portion of the cable; and
reporting said defect to a service provider of the communication network.

10. The storage medium of claim 9, comprising computer instructions for:
intercepting over one among a wireless communication medium and the portion of the cable a request to test the portion of the cable; and
performing an integrity test on the portion of the cable according to said request.

11. The storage medium of claim 10, comprising computer instructions for:
performing at least one among a group of instructions, comprising:
connectivity testing between end points of the portion of the cable,
signal integrity testing on the portion of the cable,
identification testing on the portion of the cable, and
loop-back testing on the portion of the cable; and
reporting test results to the service provider.

12. The storage medium of claim 10, comprising computer instructions for:
detecting a defect in the portion of the cable according to the integrity test; and
reporting said defect to the service provider.

13. The storage medium of claim 9, wherein the building comprises one among a dwelling, and a commercial enterprise.

14. A method, comprising the steps of:
performing at a building an integrity test on a portion of a cable of a communication network;
detecting a defect in the portion of the cable; and
reporting over the communication network said defect.

15. The method of claim 14, comprising the step of intercepting the request over one among a wireless communication medium and the portion of the cable to be tested.

16. The method of claim 14, comprising the step of performing connectivity testing between end points of the portion of the cable.

17. The method of claim 16, comprising the steps of:
detecting a connectivity defect in the portion of the cable; and
reporting the connectivity defect to a service agent of the communications network.

18. The method of claim 17, comprising the steps of:
assessing the connectivity defect; and
submitting to the service agent a resolution for the connectivity defect.

19. The method of claim 14, comprising the step of performing signal integrity testing between end points of the portion of the cable.

20. The method of claim 14, comprising the step of performing loop-back testing on the portion of the cable.
